(19) United States
(12) Patent Application Publication
(10) Pub. No.: US 2016/0210843 A1
(43) Pub. Date: Jul. 21, 2016

(54) Child "buddy" car alarm system

(71) Applicants: James Wesley Killette, Bowie, MD (US); Tammy Williams, Bowie, MD (US)

(72) Inventors: James Wesley Killette, Bowie, MD (US); Tammy Williams, Bowie, MD (US)

(21) Appl. No.: 14/544,518

(22) Filed: Jan. 15, 2015

(51) Int. Cl. G08B 21/24; B60N 2/26; B60N 2/00

(52) U.S. Cl. CPC G08B 21/24; B60N 2/002; B60N 2/26

(57) ABSTRACT

A child car seat alarm system that alerts a guardian or driver that a child is still in the child car seat or booster. The system comprises of a flat pad with weight sensors that goes under a child car seat cover or booster car seat cover. The flat pad contains weight sensors with a cord that connects to a vehicle power supply via car charger or USB charger.

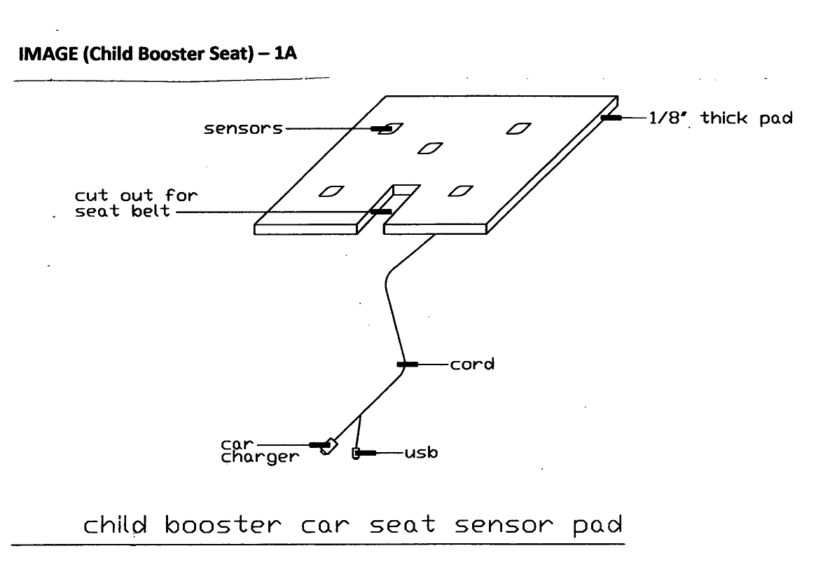

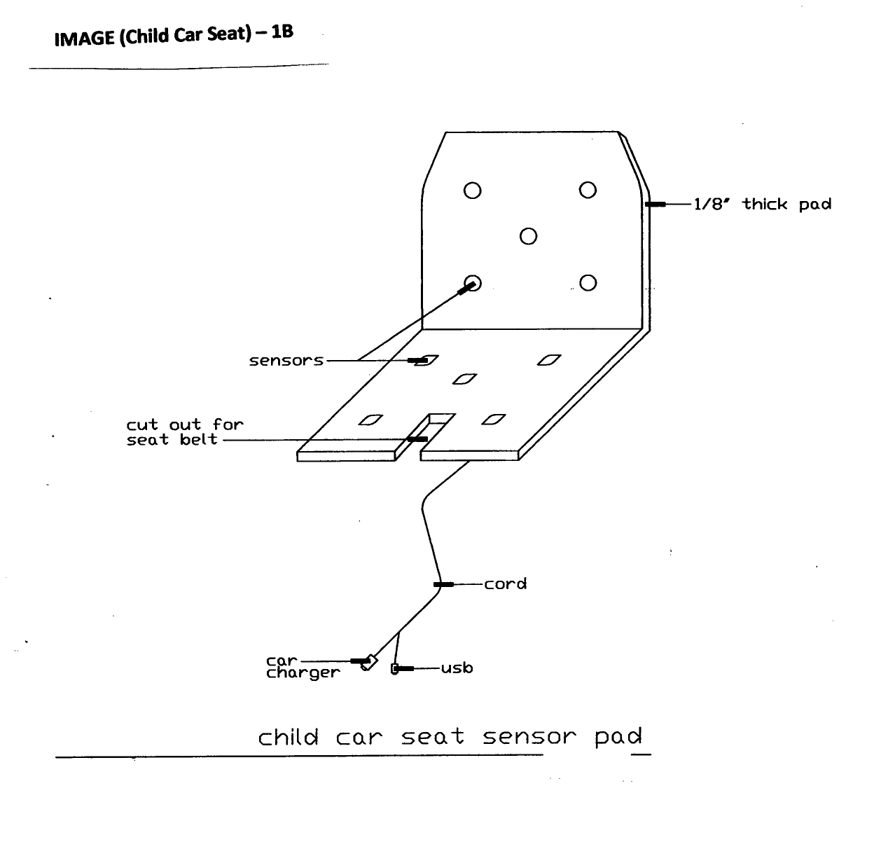

The way it functions is simple. When the vehicles' car supply or power is shut off, the child alarm sounds an alarm until the child is removed from the car seat. Once the child is removed from the seat the alarm ceases.

The scope of the present invention is to provide a child car alarm system that will alert a Guardian or driver that a child is not left, but is still in the car seat. The alarm pad can be used in any car with a car charger and/or USB charger. There's a model for a car seat and one for a booster seat.

### BACKGROUND

The present invention is directed to a child car seat alarm system that only activates when a child is placed in a child car seat or booster on a pad with weight sensors that's been placed under the cover of either seat. The pad contains weight sensors with a wired cord. The pad goes under the seating of the child car seat or booster with the wired cords hanging from the bottom of the pad. The wired cord has two selectors, one for a car charger and another for a USB charger. Once the child has been placed in the car seat or booster and the selector has been plugged in and vehicle power is turned on, it activates the child car seat or booster. After the vehicle has been turned off or power is no longer being supplied the child car seat or booster will alarm and doesn't de-activate until after the child has physically been removed from the child car seat or booster.

*Image 1A—child “booster” sensor pad shows the sensors on the seating of a ⅛″ thick pad with a cut-out for the seat belt along with a wired cord that has a car charger and USB car connector selectors.

*Image 1B—child “car seat” sensor pad shows the sensors on the seating as well as the back of a ⅛″ thick pad with a cut-out for the seat belt along with a wired cord that has a car charger and USB car connector selectors.

Due to the nature of its design, this invention doesn't allow a parent or guardian to leave the car with the child in the car seat or booster.

The scope of the present invention is to provide a child car alarm system that will alert a Guardian or driver that a child is not left, but is still in the car seat. The alarm pad can be used in any car with a car charger and/or USB charger. There's a model for a car seat and one for a booster seat.

What is claimed is:

1. A child car seat alarm system for alerting a guardian or driver with a child that a child is still in the child car seat or booster, the system comprises of:
A pad with weight sensors that goes under the cover of a child car seat or booster. The pad has a wired cord with two selectors, one for a car charger and one for a USB charger. Once plugged into selected charger if a child is still in the seat once the power is no longer being supplied to the vehicle an alarm will sound (intermittent sound) until child has been removed from the car seat or booster.

2. The child car seat of claim 1, wherein the device emits an alarm (noise) when power is no longer being supplied to the vehicle.

3. The child car seat of claim 1, wherein when power is no longer being supplied to the vehicle, the child has to physically be removed from the seat in order to shut alarm off.
